(19) United States
(12) Patent Application Publication
(10) Pub. No.: US 2010/0219383 A1
(43) Pub. Date: Sep. 2, 2010

(54) Boron-Doped Single-Walled Nanotubes(SWCNT)

(76) Inventor: Peter C. Eklund, Boalsburg, PA (US)

Correspondence Address: FROST BROWN TODD, LLC, 2200 PNC CENTER, 201 E. FIFTH STREET, CINCINNATI, OH, 45202, US

(21) Appl. No.: 12/530,369

(22) PCT Filed: Mar. 7, 2008
(86) PCT No.: PCT/US08/03072

§ 371 Date: May 7, 2010

Related U.S. Application Data
(60) Provisional application No. 60/893,513, filed on Mar. 7, 2007.

(51) Int. Cl. H01B 1/04; C01B 31/36; B05D 1/02

(52) U.S. Cl. 252/516; 423/291; 204/173; 427/427; 977/742; 977/750; 977/749

(57) ABSTRACT

The present invention generally relates to methods and apparatus for the synthesis or preparation of boron-doped single-walled carbon nanotubes (B-SWCNTs). The invention provides a high yield, single step method for producing large quantities of continuous macroscopic carbon fiber from single-wall carbon nanotubes using inexpensive carbon feedstocks wherein the carbon nanotubes are produced by in situ boron substitutional doping. In one embodiment, the nanotubes disclosed are used, singularly or in multiples, in power transmission cables, in solar cells, in batteries, as antennas, as molecular electronics, as probes and manipulators, and in composites. It is another object of this invention to provide macroscopic carbon fiber made by such a method.

### CROSS-REFERENCE TO RELATED APPLICATION

This application is the U.S. National Phase of International Application No. PCT/US2008/003072, filed Mar. 7, 2008, entitled “BORON-DOPED SINGLE-WALLED NANOTUBES (SWCNT)”, which claims the benefit of U.S. Provisional Patent Application No. 60/893,513, filed Mar. 7, 2007, which applications are hereby incorporated by reference in their entirety.

### FIELD OF THE INVENTION

The present invention generally relates to methods and apparatus for the synthesis or preparation of boron-doped single-walled carbon nanotubes (B-SWCNTs).

### BACKGROUND OF THE INVENTION

This invention relates to nano-materials and methods and apparatuses for forming nano-materials and, more particularly, to boron-doped carbon nanotubes and a method and an apparatus for forming the same.

Carbon nanotubes (CNT) possess unique properties such as small size, considerable stiffness, and electrical conductivity, which makes them suitable for a wide range of applications, including use as nanocomposites, molecular electronics, and field emission displays. Carbon nanotubes may be either multi-walled (MWCNTs) or single-walled (SWCNTs), and have diameters on the nanometer scale.

A single-walled carbon nanotube (SWCNT) consists of a single atomic layer of carbon wrapped into a seamless long cylinder. They are typically a few nanometers in diameter and many microns long. They often appear as bundles of tubes. Depending on the values of the so-called “chirality integers” (n,m) that define the way the carbon hexagons spiral up the tube axis, these atomic filaments can be shown to be either semiconducting or metallic.

In many large batch processes that produce carbon nanotubes, a mixture of nanotubes with various (n,m) and diameters is obtained. Furthermore, it is commonly believed that these various (n,m) are present in a statistical mixture of about ⅓ metallic and ⅔ semiconducting tubes.

It is known from semiconductor physics that chemical doping (i.e., the addition of impurity atoms to the semiconductor) can lead to a substantial increase in the free carrier concentration and therefore to an enhancement in the electrical and thermal conductivity.

In applications of nanotubes that require highly conducting filaments, it is either desirable to produce nanotubes powders that exhibit an increase in the fraction of metallic tubes in the material, or one can endeavor to increase the conductivity of the semiconducting fraction. This invention is about the latter, i.e., enhancing the conductivity of the semiconducting fraction of the tubes via chemical doping, and doing so during the synthesis of the nanotubes (in situ). The present invention makes use of the concept of chemical doping to SWCNT tubes during their production by the “Arc discharge” method.

### BRIEF SUMMARY OF THE INVENTION

Two approaches to doping and enhanced electrical and thermal conductivity in SWCNT are possible: (1) via several chemical approaches, attach a molecule or atom to the outside or inside of the tube wall (attachment doping). These attachments can be carried out during the synthesis of the nanotube, or afterwards. For example, a potassium atom, when fixed on the side of the nanotube wall would rather be a charged positive ion (K+) than a neutral atom (K). Consequently, the electron given up by the neutral atom in producing the ion is transferred to lower lying states in the conduction band of the nanotube wall. This transfer results in an enhanced electron population in the tube wall and an increase in the free carrier (electron) concentration. A second route to enhanced free carrier concentration in the SWCNT wall is also possible. In (2), an element (e.g., boron or B) is substituted for some of the carbon atoms in the tube wall. This second form of chemical doping (called substitutional doping) also leads to an enhanced free carrier concentration and higher electrical conductivity.

The advantage of “substitutional” doping over “attachment” doping is in the stability of the material. Unfortunately, not many atom types can be substituted for carbon in the nanotube wall. From work in graphite, it is known that boron is the only atom that is small enough to be substituted for a C-atom in an sp2-bonded carbon layer in graphite (graphene layer) and have the layer structure retain the characteristic in-plane honeycomb structure. One therefore expects B-substitution to be possible in the wall of carbon nanotubes with a minimal distortion of neighboring carbon hexagons. Therefore, a semiconducting tube doped with boron, i.e., a B-doped SWCNT (i.e., B-SWCNT) is anticipated and this doped tube would be expected to exhibit more free carries than in the undoped state and therefore be a significantly better electrical and thermal conductor than a pristine (undoped) semiconducting tube with the same chiral indices (n,m).

This prediction indicates that B-SWCNTs should be the desirable form of nanotube in applications where a highly electrical conducting composite media are required via the mixing of nanotubes and say a polymer host, such as for the case of low mass density electromagnetic interference (EMI) shielding and for a transparent conductive films, such as required in touch screen technology. When polymer-nanotube composites are mentioned for high strength EMI applications, one should consider B-doped SWCNTs as the most appropriate way to add mechanical strength and raise the conductivity in the nanotube composite.

Carbon nanotubes can be grown in an arc discharge between carbon electrodes in the presence of He and other gases. One of the electrodes should contain a catalyst in the form of small particles well dispersed amongst the carbon. The ion current between the electrodes vaporizes the material in the consumable catalyzed carbon (CC) electrode and presumably small metal particles form in the plasma discharge which can seed the growth of either individual SWCNT or bundles of SWCNTs; the tails of these filaments are attached to the metal particles during growth.

Surprisingly, the present invention provides for materials and methods of introducing boron into the vapor phase in the discharge along with the carbon vapor, to form boron-doped, single-walled carbon nanotubes (B-SWCNTs). There have been claims that B-doping has occurred during synthesis, but there has not been substantial proof provided that the boron is indeed substituted in the tube wall. Therefore, the present invention provides for the two-fold discovery: (1) in situ boron-doping has not been demonstrated via demonstration of p-type conduction of the nanotubes and (2) the present invention is able to introduce B-dopant in a large production scale Arc Discharge process.

The electrodes for the arc discharge method are prepared by incorporating ˜1-10 atomic % boron as boron carbide (B₄C) or some suitable other form, e.g., boron oxide (B₂O₃), boron nitride (BN) and boron phosphide (BP), with the main ingredients, e.g., carbon and binder. The electrodes are hot pressed at 1-4 tons for 2-10 h at 200 C and then annealed at 1000 C in nitrogen gas (N₂) for 5-10 h.

In one embodiment of the present invention, the electrodes are introduced into the Arc Discharge (AD) chamber and a gap of 1-4 mm is maintained between the electrodes while passing currents of ˜100-400 A between the electrodes. The discharge vaporizes the carbon and produces a SWCNT soot.

In one embodiment, a catalyst is incorporated into one or more electrodes. The catalyst is preferably one or more Group VI or VIII transition metals. In another embodiment, boron and nickel are incorporated in one or more carbon electrodes. The electrode may also incorporate one or more binders. In another embodiment, the catalyst is Fe, Co or Ni and/or their alloys. In another embodiment, a third element, e.g., Mo or a rare earth, e.g., Y is added. In another embodiment, boron and nickel-yttrium are incorporated in one or more carbon electrodes.

In one embodiment, the methods of the present invention produce 100 grams SWCNT soot in ˜2 hours.

In another embodiment, the SWCNTs are processed by post synthesis purification by selective oxidation and acid reflux.

In the present invention, boron is substituted for carbon in the sp2 framework of SWCNTs. The B-doped SWCNT can be produced in an industrial scale with controlled boron concentration.

In one embodiment, boron-doped nanotube films can be deposited on a wide range of substrates with desired thickness. Such B-SWCNT films have a much lower sheet resistance than that of similar thickness SWCNT films.

In another embodiment, a method for producing tubular carbon molecules of about 5 to 500 nm in length is also disclosed. The method includes the steps of forming single-wall nanotube containing-material to form a mixture of tubular carbon molecules having lengths in the range of 5-500 nm and isolating a fraction of the molecules having substantially equal lengths.

In one embodiment, the nanotubes disclosed are used, singularly or in multiples, in power transmission cables, in solar cells, in batteries, as antennas, as molecular electronics, as probes and manipulators, and in composites.

Accordingly, it is an object of this invention to provide a high yield, single step method for producing large quantities of continuous macroscopic carbon fiber from single-wall carbon nanotubes using inexpensive carbon feedstocks wherein the carbon nanotubes are produced by in situ boron substitutional doping.

It is another object of this invention to provide macroscopic carbon fiber made by such a method.

The invention provides nanotube films and articles and methods of making the same. Under one aspect of the invention, a conductive article includes an aggregate of nanotube segments in which the nanotube segments contact other nanotube segments to define a plurality of conductive pathways along the article.

Under other aspects of the invention, the nanotube segments may be single walled carbon nanotubes, or multi-walled carbon nanotubes. The various segments may have different lengths and may include segments having a length shorter than the length of the article.

The articles so formed may be disposed on substrates, and may form an electrical network of nanotubes within the article itself. Under other aspects of the invention, conductive articles may be made on a substrate by forming a nanotube fabric on the substrate, and defining a pattern within the fabric in which the pattern corresponds to the conductive article.

Under other aspects of the invention, the nanotube fabric is formed by depositing a solution of suspended nanotubes on a substrate. The deposited solution may be spun to create a spin-coating of the solution. Under other aspects of the invention, the solution may be deposited by dipping the substrate into the solution. Under other aspects of the invention, the nanotube fabric is formed by spraying an aerosol having nanotubes onto a surface of the substrate. The invention provides a method of making a film of conductive nanotubes.

It is also an object of this invention to provide a molecular array of purified boron-doped single-wall carbon nanotubes for use as a template in continuous growing of macroscopic carbon fiber.

It is also an object of the present invention to provide a new class of tubular boron-doped carbon molecules, optionally derivatized with one or more functional groups.

It is also an object of this invention to provide a number of devices employing the carbon fibers, nanotube molecular arrays and tubular carbon molecules of this invention.

It is an object of this invention to provide composite material containing boron-doped carbon nanotubes.

It is another object of this invention to provide a composite material that is resistant to delamination.

In another embodiment, a macroscopic molecular array comprising at least about 10⁶ single-wall carbon nanotubes in generally parallel orientation and having substantially similar lengths in the range of from about 5 to about 500 nanometers is disclosed.

In another embodiment, a composition of matter comprising at least about 80% by weight of single-wall carbon nanotubes is disclosed.

In still another embodiment, macroscopic carbon fiber comprising at least about 10⁶ single-wall carbon nanotubes in generally parallel orientation is disclosed.

In another embodiment, a composite material containing boron-doped nanotubes is disclosed. This composite material includes a matrix and a carbon nanotube material embedded within the matrix.

In another embodiment, a method of producing a composite material containing boron-doped carbon nanotube material is disclosed. It includes the steps of preparing an assembly of a fibrous material; adding the carbon nanotube material to the fibrous material; and adding a matrix material precursor to the carbon nanotube material and the fibrous material.

In another embodiment, a three-dimensional structure of derivatized single-wall nanotube molecules that spontaneously form is disclosed. It includes several component molecule having multiple derivatives brought together to assemble into the three-dimensional structure.

In another embodiment, a method for forming a macroscopic molecular array of tubular carbon molecules is disclosed. This method includes the steps of providing at least about 10⁶ SWCNTs; introducing a linking moiety onto at least one end or side wall of the tubular carbon molecules; providing a substrate coated with a material to which the linking moiety will attach; and contacting the tubular carbon molecules containing a linking moiety with the substrate.

In a further embodiment, the SWCNTs are of substantially similar length in the range of 50 to 500 nm. In another embodiment, the SWCNTs have a length as long as 5, 10, 15 or 20 microns, or longer depending upon the growth conditions used.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

Unless defined otherwise, all technical and scientific terms used herein have the same meaning as commonly understood to one of ordinary skill in the art to which this invention belongs. Although any methods, devices and materials similar or equivalent to those described herein may be used in the practice or testing of the invention, the preferred methods, devices and materials are now described.

All publications mentioned herein are incorporated herein by reference for the purpose of describing and disclosing the compositions and methodologies which are described in the publications which might be used in connection with the presently described invention. The publications discussed herein are provided solely for their disclosure prior to the filing date of the present application. Nothing herein is to be construed as an admission that the invention is not entitled to antedate such a disclosure by virtue of prior invention.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1(a) depicts a percolating network of SWCNT bundles (schematic). FIG. 1b. Percolation theory predicts that a sharp threshold for rapid increase in the conductivity will be observed as the density of the tubes per unit area is increased. The data are for SWCNTs dispersed in a polymer from work of P. Eklund and Y Chen et al.

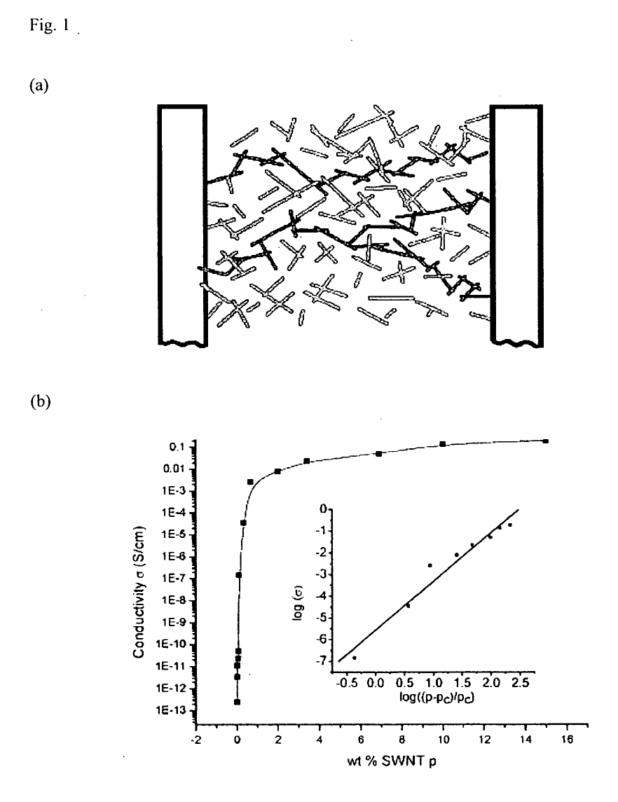

FIG. 2 shows the results of electron energy loss spectroscopy (EELS) study of a B-doped SWCNT bundle produced in the CarboLex Arc. The material was produced by adding 1 at % B₄C to the electrode(s). Electron Energy Loss Spectroscopy performed on a spot in the bundle confirms B is present at the sub 1% level. The results are shown: (a) a transmission electron microscopy (TEM) micrograph of Bundle 1A of the boron-doped SWCNTs; (b) a graph of the energy loss of Bundle 1A as determined by electron energy loss spectroscopy (EELS); (c) a transmission electron microscopy (TEM) micrograph of Bundle 2 of the boron-doped SWCNTs; (d) a graph of the energy loss of Bundle 2 as determined by electron energy loss spectroscopy (EELS). In electron energy loss spectroscopy (EELS), a material is exposed to a beam of electrons with a known, narrow range of kinetic energies. Some of the electrons will lose energy by inelastic scattering, which is primarily an interaction of the beam electron with an electron in the sample. This inelastic scattering results in both a loss of energy and a change in momentum.

FIG. 3 depicts the experimental setup used for the post-synthesis B-doping via exposure to B₂O₃ and NH₃ after electric arc synthesis of the boron-doped, single-walled carbon nanotubes (B-SWCNTs) useful in one embodiment of the present invention wherein the arc discharge created SWCNTs and boron oxide (B₂O₃) are reacted under ammonia gas pressure of from 0 to ˜200 torr and at a temperature of ˜1150° C. FIG. 1(a) depicts typical furnace conditions for the B-doping of post arc synthesis SWCNT bundles. A stream of NH₃ is passed over B₂O₃/SWCNT mixture and induces the B-doping. FIG. 1(b) a graph showing the Raman spectra showing changes in the G-band region due to B-doping as Raman shift (cm⁻¹) versus the intensity (in arbitrary units). The pressure refers to reaction conditions in FIG. 3a. The curves (from bottom to top) show the pristine sample, 0 torr, 20 ton and 1000 ton, respectively.

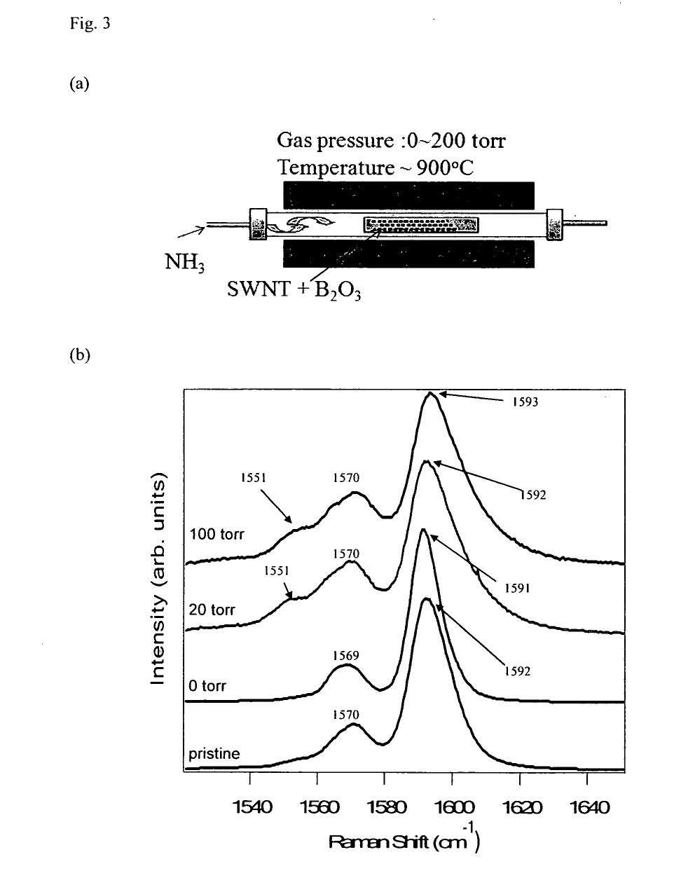

FIG. 4 is a graphical representation of boron substitution for carbon in the sp2 framework.

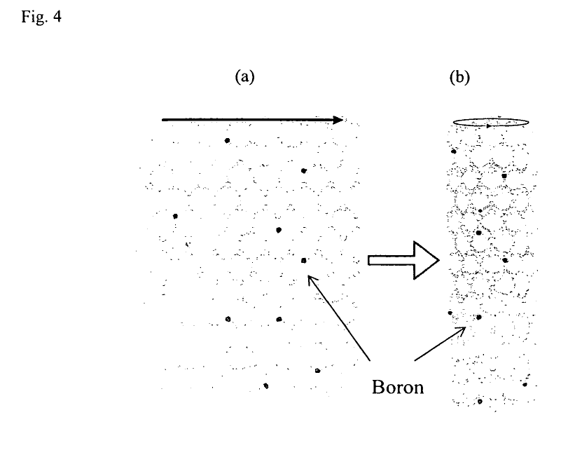

FIG. 5 shows the results of electron energy loss spectroscopy (EELS) study of post synthesis B-doping. Here, the sample was doped after arc synthesis by B₂O₃/NH₃ reaction. The results are shown: (a) a transmission electron microscopy (TEM) micrograph of 1% boron-doped SWNTs; (b) a graph of the energy loss as determined by electron energy loss spectroscopy (EELS); (c) a transmission electron microscopy (TEM) micrograph of 3% boron-doped SWNTs; (d) a graph of the energy loss as determined by electron energy loss spectroscopy (EELS).

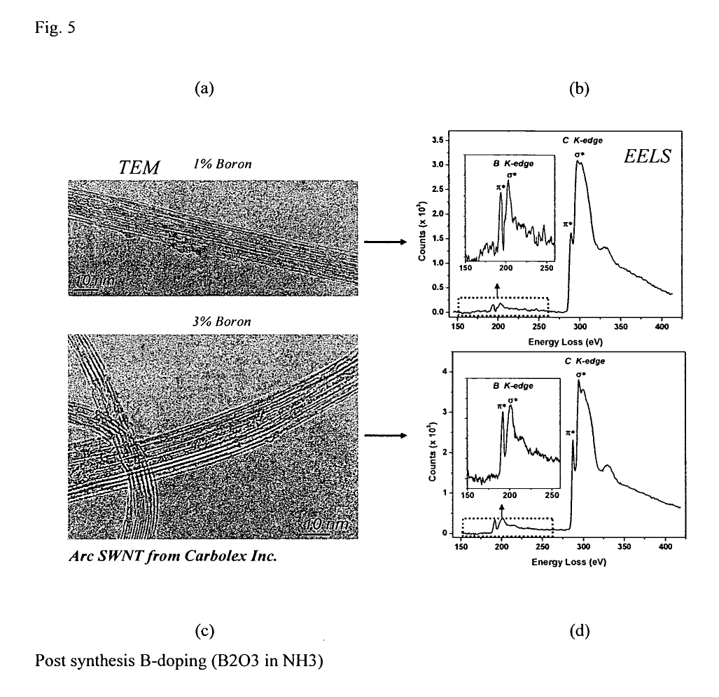

FIG. 6 depicts the Raman Spectrum of SWCNTs. FIG. 6(a) shows the tube wall damage (via the D-band scattering at ˜1350 cm-1) incurred via oxidation in can be annealed away. The band at 1350 cm-1 is the so-called disorder band (or D-band). Purification refers to HNO₃ reflux—this removes some C from the tube walls as CO2. The dangling bonds terminate later with —COOH or —OH. Annealing at 1100 C for 24 h removes these functional groups and restores wall order. In Fig. (b), the D-band must be due to B-doping, not wall disorder, as annealing cannot remove the D-band. The D-band is due to boron in the tube walls. Samples are analyzed using a laser at 514 nm and 0.46 mw power.

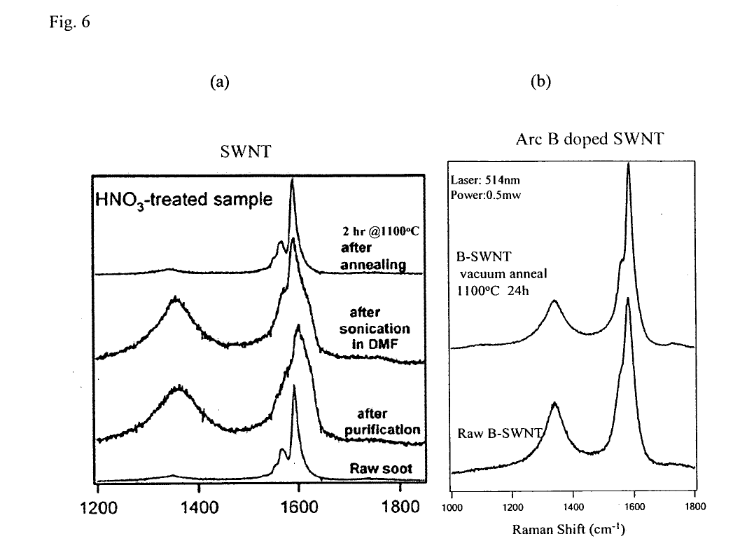

FIG. 7 shows the Raman spectra of a nanotube powder (a) The boron-doped, single-walled carbon nanotubes (B-doped SWNTs) are analyzed using a laser at 514 nm and 0.46 mw power. Each graph represents (from bottom to top) a spectral graph of undoped SWNT, 1% boron-doped SWNT; 2% boron-doped SWNT; and 3% boron-doped SWNT. These % refer to B at % added to the arc electrode. In the analysis, SWNT Raman G-band dominates the spectrum and boron substitution induces “D-band” scattering at 1350 cm⁻¹ and broadens nanotube peaks at low frequency (R-band) and high frequency (G-band).

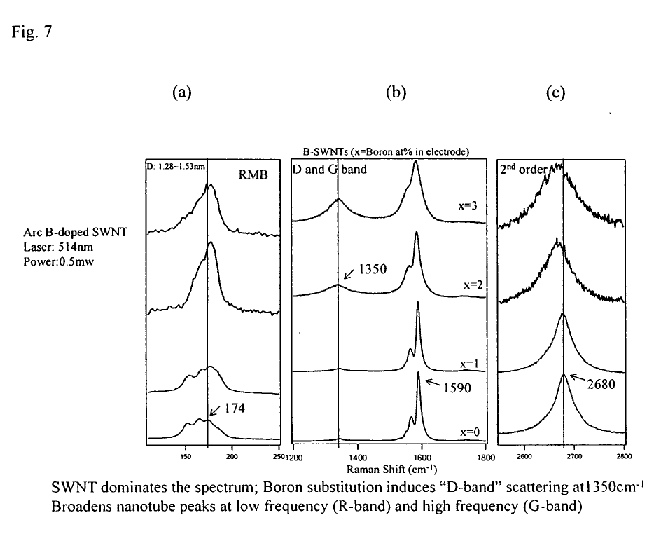

FIG. 8 is a graph showing boron-doping induced E₁₁^{S} peak shift. FIG. 6(a) shows the optical density of the boron-doped, SWNTs where X is equal to the at. % of boron in the electrode of the SWNTs. Above 2 wt. %, the E₁₁^{S} peak is suppressed due to higher tube wall conductivity. FIG. 6(b) shows the blue shift of the E₁₁^{S} peak with increasing percentages of boron doping. This upshifting of the peak can be interpreted as further direct evidence of B in the tube wall.

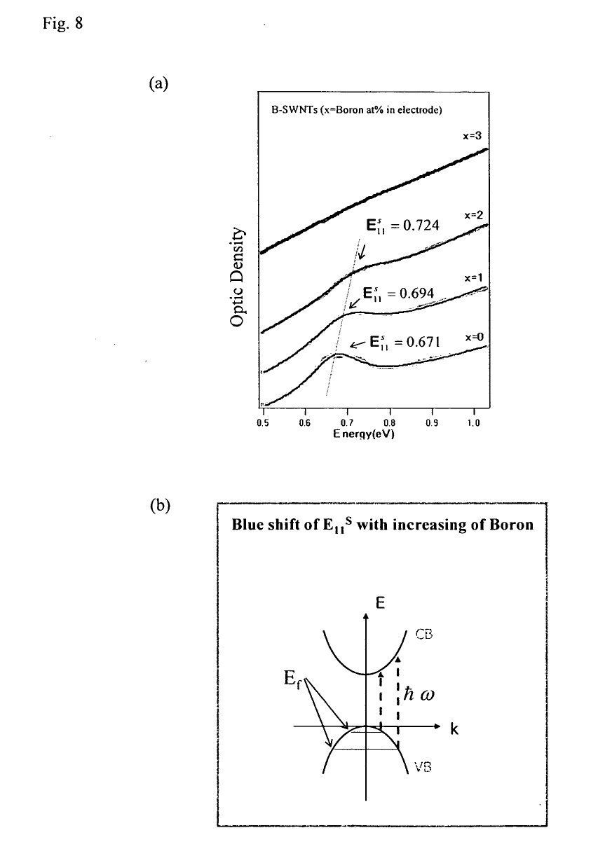

FIG. 9 is graphical depiction of sheet resistance (Rs) measurements wherein sheet resistance is calculated according to the following formula: Rs=exp(−πRA/Rs)+exp(−πRB/Rs)=1.

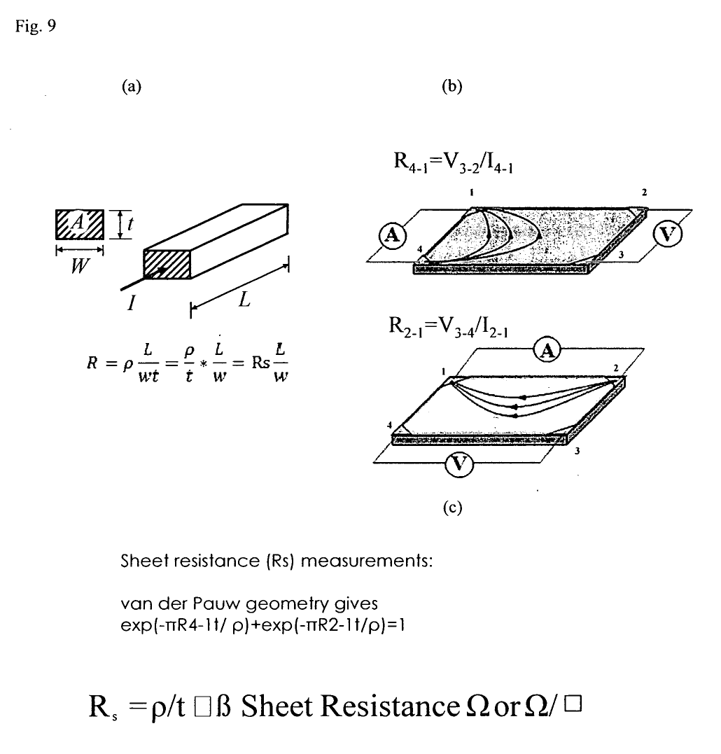

FIG. 10 is (a) an optical photograph of a SWNT film (˜3 mm×3 mm) deposited on quartz and (b) the experimental set-up showing the SWNT being deposited onto the substrate mounted on a glass slide. The tubes are dispersed in ethanol and sprayed through a mask with an air brush to produce a uniform film.

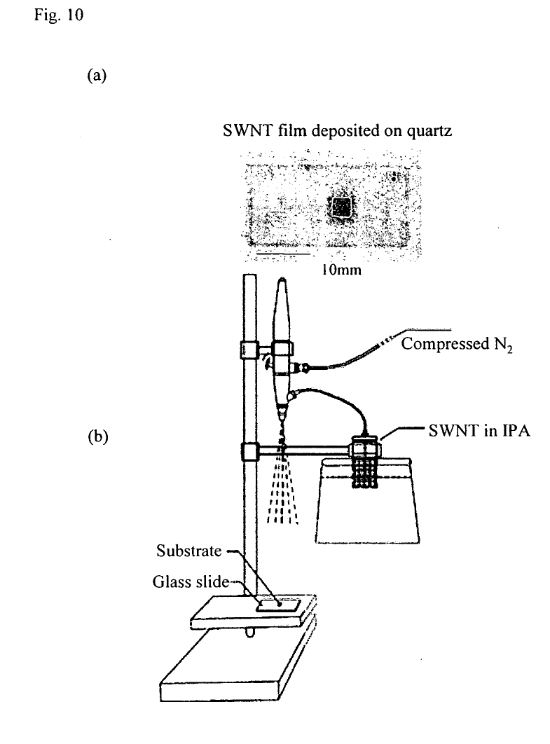

FIG. 11 is a graph showing (a) the percent transmittance (% T) of the SWNT film as a function of the wavelength (nm) and (b) the film (sheet) resistance (Rs) of doped and undoped SWNT as a function of the energy (eV). The graphs represent SWNT RAW, 3 mm×3 mm area, 2 h at 200° C. in N₂ wherein R_{A}=543 Ohms; R_{B}=583 Ohms; and Rₛ=1276 Ohms per square.

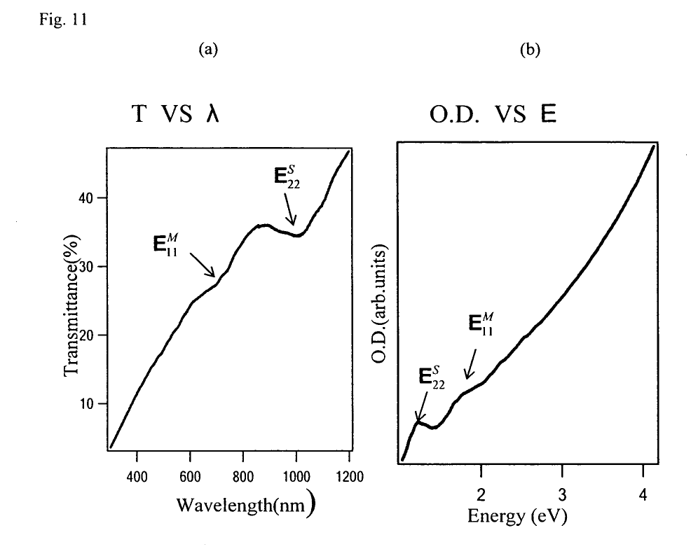

FIG. 12 is a graph showing the sheet resistance (Rₛ) of doped and undoped SWNT as a function of percent transmittance at 550 nm. The decrease in the sheet resistance is evidence that the B-doping has increased the electrical conductivity of the film, as expected.

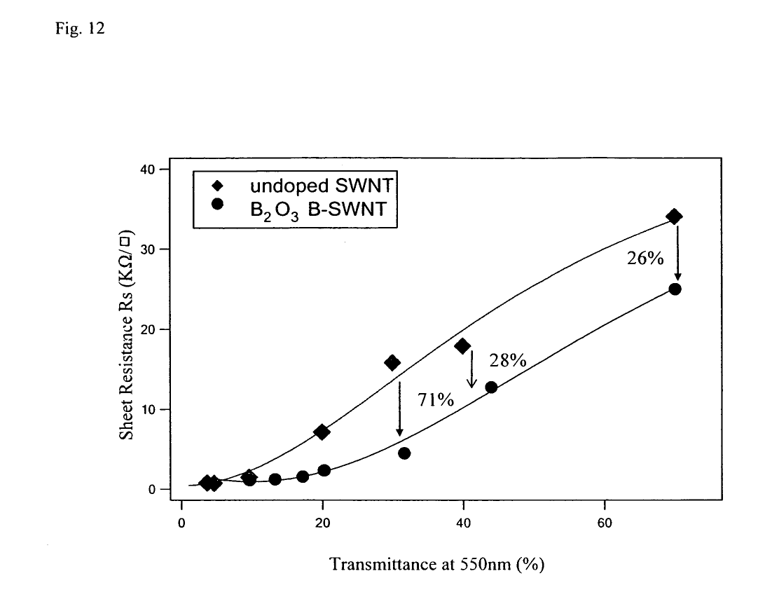

Reference will now be made in detail to the present preferred embodiment of the invention, an example of which is illustrated in the accompanying drawings. Alternate embodiments will also be discussed.

### DETAILED DESCRIPTION OF THE INVENTION

Before the present methods and devices are disclosed and described, it is to be understood that this invention is not limited to the particular process steps and materials disclosed herein as such process steps and materials may vary somewhat. It is also to be understood that the terminology used herein is used for the purpose of describing particular embodiments only and is not intended to be limiting since the scope of the present invention will be limited only by the appended claims. It must be noted that, as used in this specification and the appended claims, the singular forms “a,” “an,” and “the” include plural referents unless the content clearly dictates otherwise.

The present invention is directed to a novel composite that comprises boron-doped, single walled carbon nanotubes in an inorganic matrix. Because of the highly dispersed nature of the CNTs, these composites are electrically conductive at low levels of CNTs. Such composites can be fabricated in a variety of shaped articles, such as rods, or in the form of thin films on substrates. These composites are useful in various electronic devices, especially nano-sized devices, such as but not limited to chemical or biological sensor, molecular transistor, optoelectronic device, field-emission transistor, artificial actuators, or single-electron device.

In describing and claiming the present invention, the following terminology will be used in accordance with the definitions set out below.

The term “CNT” means carbon nanotube; “MWCNT” means multi-walled nanotube; and “SWCNT” means single walled nanotube.

The term “carbon nanotube” refers to a hollow article composed primarily of carbon atoms. The carbon nanotube can be doped with other elements, e.g., metals. In a preferred embodiment, the metal is attached on the outside of the nanotubes wall. In the present invention, Boron is used to substitute for carbon atoms in the sp2 structure of the wall. The nanotubes typically have a narrow dimension (diameter) of about 1-200 nm and a long length, where the ratio of the long dimension to the narrow dimension, i.e., the aspect ratio, is at least 10. In general, the aspect ratio is between 10 and 100000.

Carbon nanotubes of the invention are generally about 0.5-2 nm in diameter where the ratio of the length dimension to the diameter, i.e., the aspect ratio, is at least 10. In general, the aspect ratio is between 10 and 100,000. Carbon nanotubes are comprised primarily of carbon atoms, however, they may be doped with other elements, e.g., metals, which reside on the outside of the tube. The carbon-based nanotubes of the invention are single-walled nanotubes (SWCNTs). A MWCNT, for example, includes several concentric nanotubes each having a different diameter. Thus, the smallest diameter tube is encapsulated by a larger diameter tube, which in turn, is encapsulated by another larger diameter nanotube. A SWCNT, on the other hand, includes only one nanotube. CNT's have a variety of conductive properties but are typically classified as metallic or semiconducting depending on their relative conductance. For a review of the electronic properties of CNT's see Avouris et al., Applied Physics of Carbon Nanotubes (2005), 227-251. Editor(s): Rotkin, Slava V.; Subramoney, Shekhar. Publisher: Springer GmbH, Berlin, Germany.

Carbon nanotubes, and in particular the single-wall carbon nanotubes of this invention, are useful for making electrical connectors in micro devices such as integrated circuits or in semiconductor chips used in computers because of the electrical conductivity and small size of the carbon nanotube. The carbon nanotubes are useful as antennas at optical frequencies, and as probes for scanning probe microscopy such as are used in scanning tunneling microscopes (STM) and atomic force microscopes (AFM). The carbon nanotubes may be used in place of, or in conjunction with, carbon black in tires for motor vehicles. The carbon nanotubes are also useful as supports for catalysts used in industrial and chemical processes such as hydrogenation, reforming and cracking catalysts. They are also useful for EMI and filed emission devices FEDs.

Ropes of B-doped single-wall carbon nanotubes made by this invention are metallic, i.e., they will conduct electrical charges with a relatively low resistance. Ropes are useful in any application where an electrical conductor is needed, for example as an additive in electrically conductive paints or in polymer coatings or as the probing tip of an STM.

In defining carbon nanotubes, it is helpful to use a recognized system of nomenclature. In this application, the carbon nanotube nomenclature described by M. S. Dresselhaus, G. Dresselhaus, and P. C. Eklund, Science of Fullerenes and Carbon Nanotubes, Chap. 19, especially pp. 756 760, (1996), published by Academic Press, 525 B Street, Suite 1900, San Diego, Calif. 92101-4495 or 6277 Sea Harbor Drive, Orlando, Fla. 32877 (ISBN 0-12-221820-5), which is hereby incorporated by reference, will be used. The single wall tubular fullerenes are distinguished from each other by double index (n,m) where n and m are integers that describe how to cut a single strip of hexagonal “chicken-wire” graphite so that it makes the tube perfectly when it is wrapped onto the surface of a cylinder and the edges are sealed together. When the two indices are the same, m=n, the resultant tube is the to be of the “arm-chair” (or n,n) type, since when the tube is cut perpendicular to the tube axis, only the sides of the hexagons are exposed and their pattern around the periphery of the tube edge resembles the arm and seat of an arm chair repeated n times. Arm-chair tubes are a preferred form of single-wall carbon nanotubes since they are metallic, and have extremely high electrical and thermal conductivity. In addition, all single-wall nanotubes have extremely high tensile strength.

### Arc Discharge Boron Doping

In a first embodiment of the present invention, a method for forming boron-doped carbon nanotubes comprises the following steps:
a) providing a first and second carbon sources wherein at least one carbon source is a carbon rod (the first, cathode connected rod) that comprises boron;
b) connecting a boron-containing carbon rod to a negative terminal (cathode) of the electric arc discharge supply;
c) connecting a second rod to a positive terminal (anode) of an electric arc discharge supply;
d) placing the first and second rods adjacent to each other in order to create an arc gap;
e) putting the rods into an arc discharge reaction chamber, creating a vacuum in the reaction chamber, and introducing a protecting gas (e.g., He) at a predetermined pressure therein; and
f) applying a discharge current between the first and second rods whereby boron-doped carbon nanotubes are formed.

In one embodiment, the second rod is a carbon rod. In another embodiment, the second rod is a substantially pure graphite rod or a boron-containing carbon rod. In another embodiment, the second rod is not consumed in the reaction. In another embodiment, the second rod is a boron-containing carbon rod that is consumed by alternating the current direction of the arc discharge current. In another embodiment, the alternating frequency of the current direction of the arc discharge current is between 1 second and 1 KHz. In another embodiment, the second rod is substantially free of interfering materials.

In another embodiment, the first and second carbon sources are first and second carbon rods formed by pressing a catalyst powder and high purity graphite particles. In another embodiment, the carbon source further comprises from about 5 to about 50% of a binder. In another embodiment, the binder is Grade GC Dylon paste carbon cement supplied by Dylon, a commercially available binding paste made of graphite, carbon, furfuryl alcohol, and phenolic resin. In another embodiment, the carbon source further comprises from about 10 to about 30% of Grade GC Dylon paste carbon cement. In another embodiment, the carbon source further comprises from about 0.1 to about 10% carbon fibers. In another embodiment, the carbon fibers are in the range of about 0.5 to about 30 microns.

In another embodiment, the anodes comprise uniformly mixed composite rods made by mixing a paste produced from mixing high-purity metals or metal oxides at the ratios given below with graphite powder and Grade GC Dylon paste carbon cement supplied by Dylon and placing the mixture in a mold and hot pressing at from about 1 to about 4 tons or more of pressure for about 2 to about 10 h at 200 C and then annealing in an inert gas (N₂) for about 1-24 hours, preferably 5-10 hours. The rod annealing temperature range may be 400 to 1500 C., most preferably 700 to 1200 C. In one embodiment, the rods are annealed at 1000 C.

In another embodiment, the mixed composite rods comprise from about 5 to about 50% of the electrode mass.

The boron-carbon electrodes for the arc discharge method are prepared by incorporating from about 0.1 atomic weight percent (at. wt. %) to about 15 at. wt. % of boron. In another embodiment, the boron-carbon electrodes for the arc discharge method are prepared by incorporating from about 1 at. wt. % to about 10 at. wt. % of boron.

In one embodiment, the boron is supplied as elemental boron, as boron carbide (B₄C) or some suitable other form, e.g., boron oxide (B₂O₃), boron nitride (BN) and boron phosphide (BP), along with the main ingredients, e.g., carbon and binder.

In one embodiment of the present invention, the electrodes are introduced into the Arc Discharge (AD) chamber and a gap of 1-4 mm is maintained between the electrodes while passing currents of ˜100-400 A between the electrodes. The discharge vaporizes the carbon and produces a SWCNT soot.

In another embodiment, the catalyst powder comprises nickel powder, ytterbia powder, a composite of nickel powder and ytterbia powder, or cobalt powder. In alternative embodiments, other suitable materials such as pure cobalt powder, pure nickel powder or the like can be used as the catalyst and pressed with the graphite particles. In another embodiment, ytterbium metal is used.

In one embodiment, the protecting gas comprises helium, argon, nitrogen, hydrogen or mixtures thereof. Furthermore, a cooling jacket can be used around the arc discharge reaction chamber to avoid excessive build-up of heat therein.

In another embodiment, the carbon rods each have a diameter in the range from 2 to 100 millimeters. In another embodiment, the carbon rods each have a diameter in the range from 6 to 50 millimeters.

In one embodiment, the arc gap is about in the range from about 1 to about 6 mm. In another embodiment, the arc gap is about in the range from about 1 to about 4 mm. In another embodiment, the arc gap is maintained at about 1.5 to 2 millimeters. In another embodiment, the arc gap is maintained at a distance of at least 0.5, 0.6, 0.7, 0.8, 0.9, 1.0, 1.1, 1.2, 1.3, 1.4, 1.5, 1.6, 1.7, 1.8, 1.9, or 2 mm.

In another embodiment, the discharge current is in the approximate range from 50 to 400 amps. In another embodiment, the discharge current is in the approximate range from 90 to 300 amps. In another embodiment, the discharge current is in the approximate range from 100 to 200 amps.

In another embodiment, diborane gas (B₂O₆) is introduced into the arc discharge during nanotube synthesis in order to increase boron substitution in the SWCNTs.

### Post-Synthesis Boron Doping

In a second embodiment of the present invention, a method for forming boron-doped carbon nanotubes comprises the following steps:
a) providing SWCNT's;
b) mixing the SWCNTs with a boron-containing and reactive material;
c) reacting the SWCNTs with the boron-containing and reactive material by increasing the temperature and adding ammonia;
whereby boron-doped carbon nanotubes are formed.

In one embodiment, the boron-containing and reactive material is a boron metal or boron compound such as boron carbide, boron oxides, boron nitrides, borated ceramics, borated hydrocarbons, boron glass, and boron mixtures with other neutron reactive elements and nuclides.

In another embodiment, the boron-containing and reactive material is boric oxide (B₂O₃). In another embodiment, the boron-containing and reactive material is boron carbide (BC₄).

In one embodiment, the SWCNTs with boric oxide (B₂O₃) mixture is first degassed with an inert gas, e.g., nitrogen (N₂) before reacting or during reaction. In other embodiments, the choice of boron-containing and reactive material may necessitate the addition of an additional carrier gas component to induce decomposition and/or reaction with the SWCNT.

In another embodiment, the system pressure is maintained at about 50 to about 1000 ton. In another embodiment, the system pressure is maintained at about 100 to about 400 torr. In another embodiment, the system pressure is maintained at about 200 torr. In another embodiment, a boron-containing compound is used to react with SWCNTs under heat and a gas is also added to the arc chamber to promote the decomposition of the B-containing chemical thereby inducing the boron-substitution.

In another embodiment, the system temperature is maintained at about 600 to about 1400 C. In another embodiment, the system temperature is maintained at about 800 to about 1200 C. In another embodiment, the system temperature is maintained at about 800 to about 1100 C. In another embodiment, the system temperature is maintained at about 800 to about 950 C. In another embodiment, the system temperature is maintained at about 825 to about 925 C. In another embodiment, the system temperature is maintained at about 900 C.

In another embodiment, the reaction time is from about 1 hour to about 24 hours. In another embodiment, the reaction time is from about 2 hour to about 8 hours. In another embodiment, the reaction time is from about 1 hour to about 4 hours.

In another embodiment, the method further comprises cooling the formed boron-doped nanotubes. In another embodiment, the method further comprises washing the boron-doped nanotubes to remove residual reactants. In another embodiment, the method further comprises dispersing the collected boron-doped nanotubes in a solvent. In another embodiment, the solvent is an alcohol. In another embodiment, the solvent is ethanol. In another embodiment, the method further comprises spraying the solvent-dispersed boron-doped nanotubes onto a substrate to form a thin film. In one embodiment, the substrate is formed of a material such as silicon, glass, quartz, silicon oxide (SiO₂), or aluminum oxide (Al₂O₃).

In another embodiment, the SWCNTs used for the post-synthesis boron doping are produced by arc discharge, laser ablation and/or chemical vapor deposition. Nanotubes of varying purity may also be purchased from several vendors, such as Carbon Nanotubes, Inc., Carbolex, Southwest Nanotechnologies, EliCarb, Nanocyl, Nanolabs, and BuckyUSA

In selecting a solvent for a nanotube composition, the intended application for the nanotube composition is considered. The solvent meets or exceeds purity specifications required in the fabrication of intended application. The semiconductor manufacturing industry demands adherence to the specific standards set within the semiconductor manufacturing industry for ultra-clean, static-safe, controlled humidity storage and processing environments. Many of the common nanotube handling and processing procedures are simply incompatible with the industry standards. Furthermore, process engineers resist trying unfamiliar technologies. According to one aspect of the present invention, a solvent for use in a nanotube composition is selected based upon its compatibility or compliance with the electronics and/or semiconductor manufacturing industry standards.

Exemplary solvents that are compatible with many semiconducting fabrication processes, including but not limited to CMOS, bipolar, biCMOS, and MOSFET, include ethyl lactate, dimethyl sulfoxide (DMSO), monomethyl ether, 4-methyl-2 pentanone, N-methylpyrrolidone (NMP), t-butyl alcohol, methoxy propanol, propylene glycol, ethylene glycol, gamma butyrolactone, benzyl benzoate, salicyladehyde, tetramethyl ammonium hydroxide and esters of alpha-hydroxy carboxylic acids. In one or more embodiments, the solvent is a non-halogen solvent, or it is a non-aqueous solvent, both of which are desired in certain electronic fabrication processes. In one or more embodiments, the solvent disperses the nanotubes to form a stable composition without the addition of surfactants or other surface-active agents.

### Alternate Boron Doping

In another embodiment, the SWCNTs used for post-synthesis boron doping are produced by arc discharge, laser ablation and/or chemical vapor deposition.

In one embodiment, boron-containing and reactive material is dissolved or suspended in nanoparticulate form in an appropriate solvent or surfactant and then a plurality of SWCNTs are added to form a mixture providing improved contact between the boron-containing and reactive material and the SWCNTs thereby improving the production of the boron-doped nanotubes.

In one embodiment, the boron-doping process comprises the steps:
(a) providing a plurality of single-walled carbon nanotubes synthesized in a process that provides for a limited amount of wall defects (reactive sites);
(b) reacting a boron-containing and reactive material and single-walled carbon nanotubes in an appropriate solvent or surfactant to form a product; and
(c) heating the product to a temperature of about 600 to about 1400 C for a time sufficient to produce boron-doped single-walled carbon nanotubes.

In another embodiment, the boron-doping process comprises the steps:
(a) providing a plurality of SWCNTs synthesized in a process that provides for a limited amount of wall defects (reactive sites);
(b) mixing boron-containing and reactive material and SWCNTs in an appropriate solvent or surfactant to form a mixture;
(c) combining the boron-containing and reactive material and SWCNTs in the mixture and allowing the material to react with the SWCNTs for an appropriate time to produce a product (a boron-SWCNT product); and
(d) heating the product to a temperature of about 600 to about 1400 C for a time sufficient to produce a boron-doped SWCNT product.

Optionally, the method further comprises step (e), filtering and/or drying to obtain the SWCNT product or evaporate the solvent to produce a Boron-SWCNT product before, during or after heating in step (d). In one embodiment, the drying is by evaporating the solvent.

In another embodiment, the boron-containing and reactive material is ultrasonically dissolved in an appropriate solvent or surfactant. In another embodiment, the boron-containing and reactive material is dispersed into a metastable suspension with sufficient life to allow good mixing between nanotubes and suspension.

In another embodiment, the boron-containing and reactive material is dissolved in an appropriate solvent to form a saturated solution. In certain embodiments, the solvent may comprise an organic solvent, and in other embodiments the solvent may comprise an aqueous solvent. The method further comprises that at least one component in solution or suspension interacts (attaches, binds, etc.) to the SWCNT surface.

In one embodiment, the boron-containing and reactive material is a boron metal or boron compound such as boron carbide, boron oxides, boron nitrides, borated ceramics, borated hydrocarbons, boron glass, and boron mixtures with other neutron reactive elements and nuclides.

In another embodiment, the boron-containing and reactive material is boric oxide (B₂O₃). In another embodiment, the boron-containing and reactive material is boron carbide (BC₄).

In another embodiment, the boron-containing and reactive material is ultrasonically dissolved in an appropriate solvent or surfactant. In another embodiment, the boron-containing and reactive material is dissolved in an appropriate solvent or surfactant to form a saturated solution. In certain embodiments, the solvent may comprise an organic solvent, and in other embodiments the solvent may comprise an aqueous solvent. The method further comprises the at least one polymer interacting with at least one SWCNT surface. In certain embodiments, the at least one polymer functionalizes the at least one carbon nanotube.

In some embodiments, the solvent comprises one selected from the group consisting of: chloroform, chlorobenzene, water, acetic acid, acetone, acetonitrile, aniline, benzene, benzonitrile, benzyl alcohol, bromobenzene, bromoform, 1-butanol, 2-butanol, carbon disulfide, carbon tetrachloride, cyclohexane, cyclohexanol, decalin, dibromethane, diethylene glycol, diethylene glycol ethers, diethyl ether, diglyme, dimethoxymethane, N,N-dimethylformamide, ethanol, ethylamine, ethylbenzene, ethylene glycol ethers, ethylene glycol, ethylene oxide, formaldehyde, formic acid, glycerol, heptane, hexane, iodobenzene, mesitylene, methanol, methoxybenzene, methylamine, methylene bromide, methylene chloride, methylpyridine, morpholine, naphthalene, nitrobenzene, nitromethane, octane, pentane, pentyl alcohol, phenol, 1-propanol, 2-propanol, pyridine, pyrrole, pyrrolidine, quinoline, 1,1,2,2-tetrachloroethane, tetrachloroethylene, tetrahydrofuran, tetrahydropyran, tetralin, tetramethylethylenediamine, thiophene, toluene, 1,2,4-trichlorobenzene, 1,1,1-trichloroethane, 1,1,2-trichloroethane, trichloroethylene, triethylamine, triethylene glycol dimethyl ether, 1,3,5-trimethylbenzene, m-xylene, o-xylene, p-xylene, 1,2-dichlorobenzene, 1,3-dichlorobenzene, and 1,4-dichlorobenzene.

In another embodiment, the solvent is an alcohol, water or mixtures thereof. In another embodiment, the alcohol is selected from the group consisting of methanol, ethanol, 2,2,2-trifluoroethanol, 2-propanol, 2-butanol, n-pentanol, n-hexanol, cyclohexanol and n-heptanol.

“Surfactants” are generally molecules having polar and non-polar ends and which commonly position at interfaces to lower the surface tension between immiscible chemical species. Anionic, cationic or nonionic surfactants, with anionic and nonionic surfactants being more preferred, can be used in an appropriate solvent medium. Water is an example of an appropriate solvent medium. Examples of anionic surfactants include, but are not limited to SARKOSYL® NL surfactants (SARKOSYL® is a registered trademark of Ciba-Geigy UK, Limited; other nomenclature for SARKOSYL NL surfactants include N-lauroylsarcosine sodium salt, N-dodecanoyl-N-methylglycine sodium salt and sodium N-dodecanoyl-N-methylglycinate), polystyrene sulfonate (PSS), sodium dodecyl sulfate (SDS), sodium dodecyl sulfonate (SDSA), sodium alkyl allyl sulfosuccinate (TREM) and combinations thereof. A preferred anionic surfactant that can be used is sodium dodecyl sulfate (SDS). Examples of cationic surfactants that can be used, include, but are not limited to, dodecyltrimethylammonium bromide (DTAB), cetyltrimethylammonium bromide (CTAB), cetyltrimethylammonium chloride (CTAC) and combinations thereof. An example of a preferred cationic surfactant that can be used is dodecyltrimethylammonium bromide. Examples of nonionic surfactants include, but are not limited to, SARKOSYL® L surfactants (also known as N-lauroylsarcosine or N-dodecanoyl-N-methylglycine), BRIJ® surfactants (BRIJ® is a registered trademark of ICI Americas, Inc.; examples of BRIJ surfactants are polyethylene glycol dodecyl ether, polyethylene glycol lauryl ether, polyethylene glycol hexadecyl ether, polyethylene glycol stearyl ether, and polyethylene glycol oleyl ether), PLURONIC® surfactants (PLURONIC® is a registered trademark of BASF Corporation; PLURONIC surfactants are block copolymers of polyethylene and polypropylene glycol), TRITON®-X surfactants (TRITON® is a registered trademark formerly owned by Rohm and Haas Co., and now owned by Union Carbide; examples of TRITON-X surfactants include, but are not limited to, alkylaryl polyethether alcohols, ethoxylated propoxylated C₈-C₁₀ alcohols, t-octylphenoxypolyethoxyethanol, polyethylene glycol tert-octylphenyl ether, and polyoxyethylene isooctylcyclohexyl ether), TWEEN® surfactants (TWEEN® is a registered trademark of ICI Americas, Inc; TWEEN surfactants include, but are not limited to, polyethylene glycol sorbitan monolaurate (also known as polyoxyethylenesorbitan monolaurate), polyoxyethylene monostearate, polyoxyethylenesorbitan tristearate, polyoxyethylenesorbitan monooleate, polyoxyethylenesorbitan trioleate, and polyoxyethylenesorbitan monopalmitate), polyvinylpyrrolidone (PVP) and combinations thereof. Preferred nonionic surfactants that can be used are alkylaryl polyethether alcohols, commercially known as TRITON-X® surfactants.

In one embodiment, the solvent comprises a surfactant and water. In another embodiment, the surfactant is selected from the group consisting of anionic surfactant, cationic surfactant and nonionic surfactant.

In another embodiment, the anionic surfactant is selected from the group consisting of N-lauroylsarcosine sodium salt, N-dodecanoyl-N-methylglycine sodium salt and sodium N-dodecanoyl-N-methylglycinate, polystyrene sulfonate, sodium dodecyl sulfate, sodium dodecyl sulfonate, sodium alkyl allyl sulfosuccinate and combinations thereof.

In another embodiment, the cationic surfactant is selected from the group consisting of dodecyltrimethylammonium bromide, cetyltrimethylammonium bromide, cetyltrimethylammonium chloride and combinations thereof.

In another embodiment, the nonionic surfactant is selected from the group consisting of N-lauroylsarcosine, N-dodecanoyl-N-methylglycine, polyethylene glycol dodecyl ether, polyethylene glycol lauryl ether, polyethylene glycol hexadecyl ether, polyethylene glycol stearyl ether, polyethylene glycol oleyl ether, block copolymers of polyethylene and polypropylene glycol, alkylaryl polyethether alcohols, ethoxylated propoxylated C₈-C₁₀ alcohols, t-octylphenoxypolyethoxyethanol, polyethylene glycol tert-octylphenyl ether, polyoxyethylene isooctylcyclohexyl ether, polyethylene glycol sorbitan monolaurate, polyoxyethylene monostearate, polyoxyethylenesorbitan tristearate, polyoxyethylenesorbitan monooleate, polyoxyethylenesorbitan trioleate, and polyoxyethylenesorbitan monopalmitate, polyvinylpyrrolidone, and combinations thereof.

In another embodiment, the surfactant is sodium dodecyl sulfate. In another embodiment, the surfactant is dodecyltrimethylammonium bromide. In another embodiment, the surfactant is a selected from the group consisting of alkylaryl polyethether alcohols, ethoxylated propoxylated C₈-C₁₀ alcohols, t-octylphenoxypolyethoxyethanol, polyethylene glycol tert-octylphenyl ether, polyoxyethylene isooctylcyclohexyl ether, and combinations thereof. In another embodiment, the surfactant comprises a polymer and water.

In another embodiment, the system temperature is maintained at about 600 to about 1400 C. In another embodiment, the system temperature is maintained at about 680 to about 1200 C. In another embodiment, the system temperature is maintained at about 800 to about 1100 C. In another embodiment, the system temperature is maintained at about 800 to about 950 C. In another embodiment, the system temperature is maintained at about 825 to about 925 C. In another embodiment, the system temperature is maintained at about 900 C.

In another embodiment, a carrier gas is optionally used to remove undesirable volatile reaction products. In another embodiment, the carrier gas comprises an inert gas. In another embodiment, the carrier gas comprises argon, helium, xenon, krypton, neon, oxygen, nitrogen or mixtures thereof.

In another embodiment, the boron-containing and reactive material and SWCNTs are reacted for at least 0.1, 0.5, 1, 2, or 3 or more hours.

In some embodiments of the invention, the plurality of SWCNTs form an aggregate (such as a rope or bundle).

### In Situ and Post-Synthesis Boron Doping

In another embodiment of the present invention, a method for forming boron-doped carbon nanotubes comprises the following steps:
a) providing a first and second carbon sources wherein at least one carbon source is a carbon source that comprises boron;
b) connecting one carbon source to a negative terminal (cathode) of the electric arc discharge supply;
c) connecting a second carbon source to a positive terminal (anode) of an electric arc discharge supply;
d) placing the first and second rods adjacent to each other in order to create an arc gap;
e) putting the rods into an arc discharge reaction chamber, creating a vacuum in the reaction chamber, and introducing a protecting gas at a predetermined pressure therein;
f) applying a discharge current between the first and second rods whereby boron-doped carbon nanotubes are formed;
g) collecting the SWCNTs; and
h) reacting the SWCNTs with a boron-containing and reactive material;
whereby boron-doped carbon nanotubes are formed.

In another embodiment of the present invention, a method for forming boron-doped carbon nanotubes comprises the following steps:
a) providing a plurality of SWCNTs synthesized in a process that provides for a limited amount of wall defects (reactive sites); and
b) reacting the SWCNTs with a boron-containing and reactive material;
whereby boron-doped carbon nanotubes are formed.

In one embodiment, the boron-containing carbon source is connected to the negative terminal (cathode) of the electric arc discharge supply.

In another embodiment, the method further comprises step i) reacting the SWCNTs with the boron-containing and reactive material by increasing the temperature.

In another embodiment, the method further comprises the step of adding a carrier gas which promotes the reaction and/or carries away undesired reaction products. In one embodiment, the gas is ammonia, argon, hydrogen, methane, nitrogen, thiophene or mixtures thereof.

In one embodiment, the boron-containing and reactive material is a boron metal or boron compound such as boron carbide, boron oxides, boron nitrides, borated ceramics, borated hydrocarbons, boron glass, and boron mixtures with other neutron reactive elements and nuclides.

In another embodiment, the boron-containing and reactive material is boric oxide (B₂O₃). In another embodiment, the boron-containing and reactive material is boron carbide (BC₄). In another embodiment, the boron-containing and reactive material is boric oxide (B₂O₃) and the carrier gas is ammonia.

In another embodiment, the method further comprises refluxing the SWCNTs in an acidic environment prior to reacting with boric oxide (B₂O₃). In one embodiment; the nanotubes are refluxed by placing the nanotubes in a strong acid to oxidize amorphous carbon to CO and produce defect sites in the wall of the carbon nanotube. In one embodiment; the acid is nitric acid. In one embodiment; the nitric acid is at a concentration of 1-5M. In one embodiment; the nitric acid is at 1M, 2M, 3M, 4M or more in concentration. In another embodiment the acid is a mixture of sulfuric and nitric acid. In another embodiment, the acid is hydrochloric. In another embodiment, the second carrier gas is ammonia.

In another embodiment, the method further comprises one or more steps including washing, filtering and adjusting the pH. In another embodiment, the method further comprises adjusting the pH to a neutral pH. In another embodiment, the pH is adjusted by washing with solvent. In another embodiment, the solvent is hot water.

In one embodiment, the present invention provides for a method of forming tubular carbon nanostructures which comprises discharging a direct current arc between an anode and a cathode, the anode comprising a conducting electrode containing a carbon precursor, the discharging in the presence of a gas at a temperature and pressure such that the carbon precursor is maintained in a solid phase and for a period of time sufficient to form the tubular carbon nanostructures on the anode from the carbon precursor.

In one embodiment, the carbon precursor is selected from non-graphitizable carbon and graphitizable carbon. In another embodiment, the non-graphitizable carbon includes fullerene soot, carbon black or sucrose carbon. Graphitizable carbon includes PVC.

In another embodiment, the electrodes are prepared by incorporating ˜1-10 atomic % boron as boron carbide (B₄C) or some suitable other form, e.g., boron oxide (B₂O₃), boron nitride (BN) and boron phosphide (BP), with the main ingredients, e.g., carbon and binder. The electrodes are hot pressed at 1-4 tons for 2-10 h at 200 C and then annealed at 1000 C in nitrogen gas (N₂) for 5-10 h.

In another embodiment, the pressure is from about 50 Torr to atmospheric. In one embodiment, the tube furnace temperature for B₂O₃ post synthesis doping is in a range from about 650 C. to about 1200 C. In one embodiment, the gas is an inert gas or nitrogen.

The present invention also provides an apparatus for forming tubular carbon nanostructures which is preferably an arc-furnace. The apparatus comprises a cathode, an anode opposite the cathode, a source of voltage and current in an amount sufficient to create charged particles and to produce an arc between the anode and cathode, a source of gas to surround the arc, and the source of carbon precursor positioned adjacent the anode and within the arc, such that the arc has a sufficiently high temperature and is maintained at a pressure for a time sufficient to heat the carbon precursor to form carbon nanotubes upon the anode. The anode may have different geometries, e.g., flat or rounded.

The present invention also provides an apparatus for forming tubular carbon nanostructures which includes a resistance furnace having at least one opening adapted to receive a conveyor belt. The furnace further includes a source of carbon precursor, a gas source for adjusting the pressure, a heat source sufficient for the formation of tubular carbon nanostructures at the desired pressure. The conveyor belt is operably connected to the resistance furnace and is utilized to retain the source carbon precursor in the resistance furnace for a period of time sufficient to form the tubular carbon structures. Once they have been formed the conveyor belt takes the carbon nanotubes out of the resistance furnace for delivery to a user.

The present invention provides a method for making single-wall carbon nanotubes in which an arc discharge vaporizes material from an electrode comprising, consisting essentially of, or consisting of a mixture of carbon and one or more Group VI or Group VIII transition metals. In another embodiment, boron and nickel are incorporated in one or more carbon electrodes. The electrode may also incorporate one or more binders. In another embodiment, the catalyst is Fe, Co or Ni and/or their alloys. In another embodiment, a third element, e.g., Mo or a rare earth, e.g. Y is added. In another embodiment, boron and nickel-yttrium are incorporated in one or more carbon electrodes.

In one embodiment, the method also permits continuous operation, and the method produces single-wall carbon nanotubes in higher yield and of better quality. As described herein, the method may also be used to produce longer carbon nanotubes and longer ropes.

Carbon nanotubes may have diameters ranging from about 0.6 nanometers (nm) for a single-wall carbon nanotube up to 3 nm, 5 nm, 10 nm, 30 nm, 60 nm or 100 nm for single-wall or multi-wall carbon nanotubes. The carbon nanotubes may range in length from 50 nm up to 1 millimeter (mm), 1 centimeter (cm), 3 cm, 5 cm, or greater. The yield of single-wall carbon nanotubes in the product made by this invention is unusually high. Yields of single-wall carbon nanotubes greater than 10 wt %, greater than 30 wt % and greater than 50 wt % of the material vaporized are possible with this invention.

As will be described further, the one or more Group VI or VIII transition metals catalyze the growth in length of a carbon nanotube and/or the ropes. The one or more Group VI or VIII transition metals also selectively produce single-wall carbon nanotubes and ropes of single-wall carbon nanotubes in high yield. The mechanism by which the growth in the carbon nanotube and/or rope is accomplished is not completely understood. However, it appears that the presence of the one or more Group VI or VIII transition metals on the end of the carbon nanotube facilitates the addition of carbon from the carbon vapor to the solid structure that forms the carbon nanotube. Even if the mechanism is proved partially or wholly incorrect, the invention which achieves these results is still fully described herein.

Carbon nanotubes having at least one live end are formed when the target also comprises a Group VI or VIII transition metal or mixtures of two or more Group VI or VIII transition metals. In this application, the term “live end” of a carbon nanotube refers to the end of the carbon nanotube on which atoms of the one or more Group VI or VIII transition metals are located. One or both ends of the nanotube may be a live end. A carbon nanotube having a live end is initially produced in the apparatus of this invention by using an arc discharge to vaporize material from a target comprising carbon and one or more Group VI or VIII transition metals and then introducing the carbon/Group VI or VIII transition metal vapor to an annealing zone. A carbon nanotube having a live end will form in the annealing zone and then grow in length by the catalytic addition of carbon from the vapor to the live end of the carbon nanotube. Additional carbon vapor is then supplied to the live end of a carbon nanotube to increase the length of the carbon nanotube.

The carbon nanotube that is formed is not always a single-wall carbon nanotube; it may be a multi-wall carbon nanotube having two, five, ten or any greater number of walls (concentric carbon nanotubes). Preferably, though, the carbon nanotube is a single-wall carbon nanotubes.

The atmosphere in the reaction zone will comprise a carrier gas. Any gas that does not prevent the formation of carbon nanotubes will work as the carrier gas, but preferably the carrier gas is an inert gas such as helium, neon, argon, krypton, xenon, radon, or mixtures of two or more of these. Helium and Argon are most preferred. In one embodiment, the carrier gas introduced is a make-up amount of He, so that the gaseous contents of the arc chamber are turned over approximately once every 30 min. Typical chambers have volumes from about 1 to about 3 cubic feet. In another embodiment, the chamber is stainless steel and the walls are water cooled so that the temperature of the walls remains in the range about 20-40° C.

In one embodiment, the carrier gas is maintained at an internal pressure in the range from about 50-600 Torr during the synthesis process and a flow rate in the range from 100-500 sccm (standard cubic centimeters per minute). In another embodiment, the carrier gas is maintained at an internal pressure in the range from about 100-200 Ton during the synthesis process and a flow rate in the range from 200-500 sccm (standard cubic centimeters per minute).

In one embodiment, the carrier gas is a mixture of one or more inert gases combined with carbon dioxide gas (CO₂).

In another embodiment, the gas supplied is configured for introducing a reactant gas containing a carbon source gas into the reaction chamber for synthesizing single-wall carbon nanotubes. The carbon source gas is usually a hydrocarbon gas, such as methane, ethylene, acetylene, etc.; or a mixture of hydrocarbon gases. The reactant gas supplied also can provide hydrogen gas and/or an inert gas, which can be supplied together with the carbon source gas. The reactant gas supplier generally includes a valve for controlling a flow rate of the reactant gas.

In some embodiments of the invention, when other materials are being vaporized along with carbon, for example one or more Group VI or VIII transition metals, those compounds and vapors of those compounds will also be present in the atmosphere of the reaction zone. If a pure metal is used, the resulting vapor will comprise the metal. If a metal oxide is used, the resulting vapor will comprise the metal and ions or molecules of oxygen.

It is important to avoid the presence of too many materials that kill or significantly decrease the catalytic activity of the one or more Group VI or VIII transition metals at the live end of the carbon nanotube. It is known that the presence of too much water and/or oxygen will prevent or significantly decrease the catalytic activity of the one or more Group VI or VIII transition metals. Therefore, water and oxygen are preferably excluded from the atmosphere in the annealing zone. Ordinarily, the use of a carrier gas having less than 5 wt %, more preferably less than 1 wt % water and oxygen will be sufficient. Most preferably the water and oxygen will be less than 0.1 wt %.

In one embodiment, the electrodes are mounted inside a chamber. The reaction chamber may be made from any material that can withstand the temperatures and pressures involved. In one embodiment, stainless steel or aluminum are used.

Any Group VI or VIII transition metal may be used alone or in combination in this invention to promote CNT growth. Group VI transition metals are chromium (Cr), molybdenum (Mo), and tungsten (W). Group VIII transition metals are iron (Fe), cobalt (Co), nickel (Ni), ruthenium (Ru), rhodium (Rh), palladium (Pd), osmium (Os), Iridium (Ir) and platinum (Pt).

In one embodiment, the one or more Group VIII transition metals are selected from the group consisting of iron, cobalt, ruthenium, nickel and platinum. In another embodiment, mixtures of yttrium and nickel are used. In another embodiment, the metallic catalyst is composed of yttrium and nickel powder in the ratio of 1:4. In one specific embodiment, the yttrium and nickel powders are mixed with powdered graphite and pressed into a graphite rod, which is then used as the cathode in an electric arc discharge. In one embodiment, the anode is made in pure graphite. In another embodiment, the catalyst is Fe, Ni, Co and mixtures thereof. In one embodiment, a 50/50 mixture (by weight) of Ni and Co is used. In one embodiment, a 50/50 mixture (by weight) of Ni and Co is mixed in a 4:1 ratio with yttrium. In another embodiment, mixtures of cobalt and nickel or mixtures of cobalt and platinum are used with yttrium.

The one or more Group VI or VIII transition metals useful in this invention may be used as pure metal, oxides of metals, carbides of metals, nitrate salts of metals, or other compounds containing the Group VI or VIII transition metal. Preferably, the one or more Group VI or VIII transition metals are used as pure metals, oxides of metals, or nitrate salts of metals. The amount of the one or more Group VI or VIII transition metals that should be combined with carbon to facilitate production of carbon nanotubes having a live end, is from 0.1 to 10 atom percent, more preferably 0.5 to 5 atom percent and most preferably 0.5 to 1.5 atom percent. In this application, atom percent means the percentage of specified atoms in relation to the total number of atoms present. For example, a 1 atom % mixture of nickel and carbon means that of the total number of atoms of nickel plus carbon, 1% are nickel (and the other 99% are carbon).

In another embodiment, the electrode comprises Ni₄Y at 4 at. wt. % relative to carbon. In another embodiment, a carbon anode containing 10 atomic percentage of yttrium and 42 at % of nickel as catalyst is used. In yet another embodiment, the carbon, nickel and yttrium catalyst (C/Ni/Y) ratio is 94.8:4.2:1).

The one or more Group VI or VIII transition metals should be combined with carbon to form an electrode target for vaporization by an arc discharge as described herein. The remainder of the electrode should be carbon and may include carbon in the graphitic form, carbon in the fullerene form, carbon in the diamond form, or carbon in compound form such as polymers or hydrocarbons, or mixtures of two or more of these. In one embodiment, the carbon used to make the electrode is graphite.

It is understood that the apparatus can have yet another suitable configuration, such as an arc discharge apparatus with a plurality (e.g., a three or more) of the graphite electrodes installed therein to perform an arc discharge process.

Carbon is mixed with the one or more Group VI or VIII transition metals in the ratios specified and then combined to form an electrode that comprises the carbon and the one or more Group VI or VIII transition metals. The electrode may be made by uniformly mixing carbon and the one or more Group VI or VIII transition metals with carbon cement at room temperature and then placing the mixture in a mold. The mixture in the mold is then compressed and heated to about 130° C. for about 4 or 5 hours while the binder of the carbon cement cures. The compression pressure used should be sufficient to compress the mixture of graphite, one or more Group VI or VIII transition metals and carbon cement into a molded form that does not have voids; the molded form should maintain structural integrity. The molded form is then carbonized by slowly heating it to a temperature of 900° C. for about 8 hours under an atmosphere of flowing argon. The molded and carbonized targets are then heated to about 1200° C. under flowing argon for about 12 hours prior to their use as an electrode.

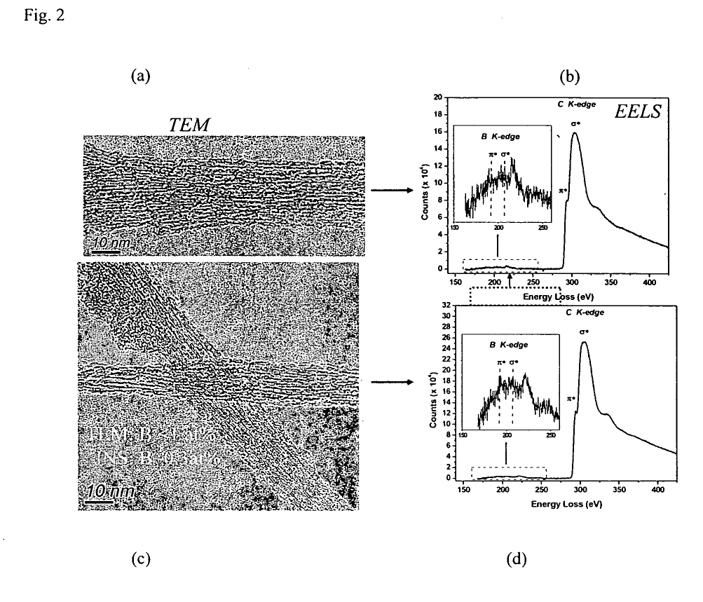

The invention may be further understood by reference to FIG. 2 which is a cross-section view of the arc discharge reaction chamber. An electrode is positioned within reaction chamber. The electrode will comprise carbon and may comprise one or more Group VI or VIII transition metals.

In one embodiment, the reaction chamber is positioned in oven, which in one embodiment comprises insulation and a heating element zone.

An inert gas such as argon or helium may be introduced to the upstream end of reaction chamber so that flow is from the upstream end of reaction chamber to the downstream end. In operation, oven is heated to the desired temperature, preferably 700 to 1300° C., usually about 900° C. Argon is introduced to the upstream end as a carrier gas. The argon may optionally be preheated to a desired temperature, which should be about the same as the temperature of oven. The arc discharge vaporizes the carbon electrodes. Vapor from target is carried toward the downstream end by the flowing carrier gas stream. If the target is comprised solely of carbon and boron, the vapor formed will be a carbon and boron vapor. If one or more Group VI or VIII transition metals are included as part of the target, the vapor will comprise carbon and one or more Group VI or VIII transition metals.

The heat from the oven and the flowing helium or argon maintain a certain zone within the inside of the reaction chamber as an annealing zone.

In one embodiment, the apparatus includes a water-cooled collector mounted inside the reaction chamber at the downstream end of reaction chamber. The water cooled collector may be maintained at a temperature of 700° C. or lower, preferably 500° C. or lower on the surface to collect carbon nanotubes that were formed in the annealing zone.

In one embodiment of the invention, carbon nanotubes having a live end can be caught or mounted on a tungsten wire in the annealing zone portion of reaction chamber.

In another embodiment of the invention, when the target comprises one or more Group VI or VIII transition metals, the vapor formed will comprise carbon and the one or more Group VI or VIII transition metals. That vapor will form carbon nanotubes in the annealing zone that will then be deposited on water cooled collector. The presence of one or more Group VI or VIII transition metals in the vapor along with carbon in the vapor preferentially forms carbon nanotubes instead of fullerenes, although some fullerenes and graphite will usually be formed as well. In the annealing zone, carbon from the vapor is selectively added to the live end of the carbon nanotubes due to the catalytic effect of the one or more Group VI or VIII transition metals present at the live end of the carbon nanotubes.

The annealing zone temperature in this embodiment can be lower than the annealing zone temperatures necessary to initially form the single-wall carbon nanotube having a live end. Annealing zone temperatures can be in the range of 400 to 1500° C., preferably 400 to 1200° C., most preferably 500 to 700° C. The lower temperatures are workable because the Group VI or VIII transition metal(s) catalyze the addition of carbon to the nanotube at these lower temperatures.

### Purification of Single-Wall Nanotubes

Carbon nanotubes in material obtained according to any of the foregoing methods may be purified according to the methods of this invention. A mixture containing at least a portion of single-wall nanotubes (“SWCNT”) may be prepared, for example, as described by Iijima, et al, or Bethune, et al. However, production methods which produce single-wall nanotubes in relatively high yield are preferred.

The product of a typical process for making mixtures containing single-wall carbon nanotubes is a tangled felt which can include deposits of amorphous carbon, graphite, metal compounds (e.g., oxides), spherical fullerenes, catalyst particles (often coated with carbon or fullerenes) and possibly multi-wall carbon nanotubes. The single-wall carbon nanotubes may be aggregated in “ropes” or bundles of essentially parallel nanotubes.

When material having a high proportion of single-wall nanotubes is purified as described herein, the preparation produced will be enriched in single-wall nanotubes, so that the single-wall nanotubes are substantially free of other material. In particular, single-wall nanotubes will make up at least 80% of the preparation, preferably at least 90%, more preferably at least 95% and most preferably over 99% of the material in the purified preparation.

The purification process of the present invention comprises heating the SWCNT-containing felt under oxidizing conditions to remove the amorphous carbon deposits and other contaminating materials. In a preferred mode of this purification procedure, the felt is heated in an aqueous solution of an inorganic oxidant, such as nitric acid, a mixture of hydrogen peroxide and sulfuric acid, or potassium permanganate. Preferably, SWCNT-containing felts are refluxed in an aqueous solution of an oxidizing acid at a concentration high enough to etch away amorphous carbon deposits within a practical time frame, but not so high that the single-wall carbon nanotube material will be etched to a significant degree. Nitric acid at concentrations from 2.0 to 2.6 M have been found to be suitable. At atmospheric pressure, the reflux temperature of such an aqueous acid solution is about 120° C.

In a preferred process, the nanotube-containing felts can be refluxed in a nitric acid solution at a concentration of 2.6 M for 24 hours. Purified nanotubes may be recovered from the oxidizing acid by filtration through, e.g., a 5 micron pore size TEFLON filter, like Millipore Type LS. Preferably, a second 24 hour period of refluxing in a fresh nitric solution of the same concentration is employed followed by filtration as described above.

Refluxing under acidic oxidizing conditions may result in the esterification of some of the nanotubes, or nanotube contaminants. The contaminating ester material may be removed by saponification, for example, by using a saturated sodium hydroxide solution in ethanol at room temperature for 12 hours. Other conditions suitable for saponification of any ester linked polymers produced in the oxidizing acid treatment will be readily apparent to those skilled in the art. Typically the nanotube preparation will be neutralized after the saponification step. Refluxing the nanotubes in 6M aqueous hydrochloric acid for 12 hours has been found to be suitable for neutralization, although other suitable conditions will be apparent to the skilled artisan.

After oxidation, and optionally saponification and neutralization, the purified nanotubes may be collected by settling or filtration preferably in the form of a thin mat of purified fibers made of ropes or bundles of SWCNTs, referred to hereinafter as “bucky paper.” In a typical example, filtration of the purified and neutralized nanotubes on a TEFLON membrane with 5 micron pore size produced a black mat of purified nanotubes about 100 microns thick. The nanotubes in the bucky paper may be of varying lengths and may consists of individual nanotubes, or bundles or ropes of up to 103 single-wall nanotubes, or mixtures of individual single-wall nanotubes and ropes of various thicknesses. Alternatively, bucky paper may be made up of nanotubes which are homogeneous in length or diameter and/or molecular structure due to fractionation as described hereinafter.

The purified nanotubes are finally dried, for example, by baking at 850° C. in a hydrogen gas atmosphere, to produce dry, purified nanotube preparations.

In another embodiment, a slightly basic solution (e.g., pH of approximately 8-12) may also be used in the saponification step. The initial cleaning in 2.6 M HNO3 converts amorphous carbon in the raw material to various sizes of linked polycyclic compounds, such as fulvic and humic acids, as well as larger polycyclic aromatics with various functional groups around the periphery, especially the carboxylic acid groups. The base solution ionizes most of the polycyclic compounds, making them more soluble in aqueous solution. In a preferred process, the nanotube containing felts are refluxed in 2-5 M HNO3 for 6-15 hours at approximately 110-125° C. Purified nanotubes may be filtered and washed with 10 mM NaOH solution on a 3 micron pore size TSTP Isopore filter. Next, the filtered nanotubes polished by stirring them for 30 minutes at 60 C. in a S/N (Sulfuric acid/Nitric acid) solution. In a preferred embodiment, this is a 3:1 by volume mixture of concentrated sulfuric acid and nitric acid. This step removes essentially all the remaining material from the tubes that is produced during the nitric acid treatment.

Once the polishing is complete, a four-fold dilution in water is made, and the nanotubes are again filtered on the 3 micron pore size TSTP Isopore filter. The nanotubes are again washed with a 10 mM NaOH solution. Finally, the nanotubes are stored in water, because drying the nanotubes makes it difficult to resuspend them.

The conditions may be further optimized for particular uses, but this basic approach by refluxing in oxidizing acid has been shown to be successful. Purification according to this method will produce single-wall nanotubes for use as catalysts, as components in composite materials, or as a starting material in the production of tubular carbon molecules and continuous macroscopic carbon fiber of single-wall nanotube molecules.

Preparation of homogeneous populations of short carbon nanotube molecules may be accomplished by cutting and annealing (reclosing) the nanotube pieces followed by fractionation. The cutting and annealing processes may be carried out on a purified nanotube bucky paper, on felts prior to purification of nanotubes or on any material that contains single-wall nanotubes. When the cutting and annealing process is performed on felts, it is preferably followed by oxidative purification, and optionally saponification, to remove amorphous carbon. Preferably, the starting material for the cutting process is purified single-wall nanotubes, substantially free of other material.

The short nanotube pieces can be cut to a length or selected from a range of lengths, that facilitates their intended use. For applications involving the individual tubular molecules per se (e.g., derivatives, nanoscale conductors in quantum devices, i.e., molecular wire), the length can be from just greater than the diameter of the tube up to about 1,000 times the diameter of the tube. Typical tubular molecules will be in the range of from about 5 to 1,000 nanometers or longer. For making template arrays useful in growing carbon fibers of SWCNT as described below, lengths of from about 50 to 500 nm are preferred.

Any method of cutting that achieves the desired length of nanotube molecules without substantially affecting the structure of the remaining pieces can be employed. The preferred cutting method employs irradiation with high mass ions. In this method, a sample is subjected to a fast ion beam, e.g., from a cyclotron, at energies of from about 0.1 to 10 giga-electron volts. Suitable high mass ions include those over about 150 AMU's such as bismuth, gold, uranium and the like.

Preferably, populations of individual single-wall nanotube molecules having homogeneous length are prepared starting with a heterogeneous bucky paper and cutting the nanotubes in the paper using a gold (Au+33) fast ion beam.

Oxidative etching, e.g., with highly concentrated nitric acid, can also be employed to effect cutting of SWCNTs into shorter lengths. For example, refluxing SWCNT material in concentrated HNO3 for periods of several hours to 1 or 2 days will result in significantly shorter SWCNTs. The rate of cutting by this mechanism is dependent on the degree of helicity of the tubes. This fact may be utilized to facilitate separation of tubes by type, i.e., (n,n) from (m,n).

The cleaned nanotube material may be cut into 50-500 nm lengths, preferably 100-300 nm lengths, by this process. The resulting pieces may form a colloidal suspension in water when mixed with a surfactant such as Triton X-100™ (Aldrich, Milwaukee, Wis.). These sable suspensions permit a variety of manipulations such as sorting by length using field flow fractionation, and electrodeposition on graphite followed by AFM imaging. Combination of the foregoing cutting techniques can also be employed.

Homogeneous populations of single-walled nanotubes may be prepared by fractionating heterogeneous nanotube populations after annealing. The annealed nanotubes may be disbursed in an aqueous detergent solution or an organic solvent for the fractionation. Preferably the tubes will be disbursed by sonication in benzene, toluene, xylene or even molten naphthalene. The primary function of this procedure is to separate nanotubes that are held together in the form of ropes or mats by van der Waals forces. Following separation into individual nanotubes, the nanotubes may be fractionated by size by using fractionation procedures which are well known, such as procedures for fractionating DNA or polymer fractionation procedures. Fractionation also can be performed on tubes before annealing, particularly if the open ends have substituents (carboxy, hydroxy, etc.), that facilitate the fractionation either by size or by type. Alternatively, the closed tubes can be opened and derivatized to provide such substituents. Closed tubes can also be derivatized to facilitate fractionation, for example, by adding solubilizing moieties to the end caps.

Electrophoresis is one such technique well suited to fractionation of SWCNT molecules since they can easily be negatively charged. It is also possible to take advantage of the different polarization and electrical properties of SWCNTs having different structure types (e.g., arm chair and zig-zag) to separate the nanotubes by type. Separation by type can also be facilitated by derivatizing the mixture of molecules with a moiety that preferentially bonds to one type of structure.

### Use of Boron-Doped SWCNTs

The nanotube composition can be placed or applied on a substrate to obtain a nanotube film, fabric or other article. A conductive article includes an aggregate of nanotubes (at least some of which are conductive), in which the nanotubes contact other nanotubes to define a plurality of conductive pathways in the article. The nanotube fabric or film desirably has a uniform porosity or density. In many applications, the nanotube fabric is a monolayer.

Many methods exist for the application procedure including spin coating, spray coating, dipping and many others known for dispersing solutions onto substrates. For thicker fabrics beyond a monolayer, more applications or more concentrated solutions may be required. In fact other techniques for application of the fabric may be required as has been outlined elsewhere (See Nanotube Films and Articles (U.S. Pat. No. 6,706,402) filed Apr. 23, 2002 and Methods of Nanotube Films and Articles (U.S. patent application Ser. No. 10/128,117) filed Apr. 23, 2002).

A further example is to coat polymer resin with the CNTs. The resultant polymer composite is then available for use as a conductive and/or reinforced material.

A further example of an application in which CNTs may be used is to form an EMI (Electro Magnetic Interference) shield. The CNTs may be formed in a composite material (e.g. glass, metal, ceramic, polymer, graphite or any combination of these), wherein the composite material is then able to shield devices or people from RF or microwave radiation.

The B-SWCNTs may also be deposited on a paper substrate to form a circuit. The paper circuit may then be used as a biodegradable electronic device, which is easily and cheaply manufactured, and can be thrown away when no longer required.

CNTs have special qualities such as good electrical and thermal conductivity and resistance to temperature. Ropes of CNTs have good tensile strength, which is useful in applications where durability are required. Also, as carbon is not easily detectable, it is also possible to make CNT circuits that can be hidden.

The tubular carbon molecules of this invention may also be used in RF shielding applications, e.g., to make microwave absorbing materials.

Single-walled nanotube molecules may serve as catalysts in any of the reactions known to be catalyzed as fullerenes, with the added benefits that the linear geometry of the molecule provides. The carbon nanotubes are also useful as supports for catalysts used in industrial and chemical processes such as hydrogenation, reforming and cracking catalysts. Materials including the SWCNT molecules can also be used as hydrogen storage devices in battery and fuel cell devices.

The tubular carbon molecules produced according to this invention can be chemically derivatized at their ends (which may be made either open or closed with a hemi-fullerene dome). Derivatization at the fullerene cap structures is facilitated by the well-known reactivity of these structures. See, “The Chemistry of Fullerenes” R. Taylor ed., Vol. 4 of the advanced Series in Fullerenes, World Scientific Publishers, Singapore, 1995; A. Hirsch, “The Chemistry of the Fullerenes,” Thieme, 1994. Alternatively, the fullerene caps of the single-walled nanotubes may be removed at one or both ends of the tubes by short exposure to oxidizing conditions (e.g., with nitric acid or O2/CO2) sufficient to open the tubes but not etch them back too far, and the resulting open tube ends maybe derivatized using known reaction schemes for the reactive sites at the graphene sheet edge.

Process parameters, including but not limited to, voltage, temperature, current density, and gas pressure, are selected that are appropriate for forming SWCNTs at an efficient rate without harming or otherwise damaging the semiconducting or metallic carbon nanotubes.

Since the period of applying the voltage depends on the discharge voltage, the discharge environment, the state of the magnetic field, the various temperatures, the shape and the type of the electrodes and the like, and thus, is not generalized, the period should be properly selected. When it is necessary to control the average length of the manufactured carbon nanotubes more precisely, the discharge period realizing the desired length of the carbon nanotubes is selected after the working curve for the discharge period and the average length of the carbon nanotubes is obtained in advance.

When the discharge plasma is generated between the electrodes, carbon is separated from the surface of the electrode, and then reacts to generate carbon nanotubes. The generated carbon nanotubes are deposited on the surface of the tip of the electrode, a neighborhood of it, and also the inner wall of the reaction container.

In one embodiment, a cooling unit (a heat releasing member and tubes) is provided to cool the magnets and it is possible to maintain stably generating discharge plasma for a long period.

In general, when carbon nanotubes are manufactured with arc discharge or the like, amorphous carbon, graphite particles, and the like are generated simultaneously with the carbon nanotubes. Namely, since other impurities are generated along with the carbon nanotubes, the supplied carbon source does not always contribute to the growth of the carbon nanotubes.

As described above, with the present invention, by manufacturing carbon nanotubes with discharge plasma such as arc discharge which enables simple manufacturing and requires only low cost, it is possible to obtain high purity carbon nanotubes while properly controlling the shape, especially the length and diameter.

The unique properties of the nano-carbon fiber produced by the present invention also permit new types of composite reinforcement. It is possible, for example, to produce a composite fiber/polymer with anisotropic properties. This can, for example, be accomplished by dispersing a number of metallic carbon nanotube fibers (e.g., from (n,n) SWCNTs) in a prepolymer solution (e.g., a poly methymethacrylate) and using an external electric field to align the fibers, followed by polymerization. Electrically conductive components can also be formed using the metallic forms of carbon nanotubes.

Applications of these carbon nanotubes containing composites include, but are not limited to, all those currently available for graphite fibers and high strength fibers such as Kevlar, including: structural support and body panels and for vehicles, including automobiles, trucks, and trains; tires; aircraft components, including airframes, stabilizers, wing skins, rudders, flaps, helicopter rotor blades, rudders, elevators, ailerons, spoilers, access doors, engine pods, and fuselage sections; spacecraft, including rockets, space ships, and satellites; rocket nozzles; marine applications, including hull structures for boats, hovercrafts, hydrofoils, sonar domes, antennas, floats, buoys, masts, spars, deckhouses, fairings, and tanks; sporting goods, including golf carts, golf club shafts, surf boards, hang-glider frames, javelins, hockey sticks, sailplanes, sailboards, ski poles, playground equipment, fishing rods, snow and water skis, bows, arrows, racquets, pole-vaulting poles, skateboards, bats, helmets, bicycle frames, canoes, catamarans, oars, paddles, and other items; mass-produced modular homes; mobile homes; windmills; audio speakers; furniture, including chairs, lamps, tables, and other modern furniture designs; soundboards for string instruments; lightweight armored products for personnel, vehicle, and equipment protection; appliances, including refrigerators, vacuum cleaners, and air conditioners; tools, including hammer handles, ladders, and the like; biocompatible implants; artificial bones; prostheses; electrical circuit boards; and pipes of all kinds.

### EXAMPLES

### Example 1

### B-SWCNT Material Characterization (e.g., B-Content in the Tube Wall)

The B-content in the SWCNTs has been determined by transmission electron microscopy (EELs) and neutron activation methods. Some fraction ˜½ of the boron in the electrodes is preferentially lost to carbon particles and amorphous carbon also produced in the ARC reaction. Electrical conductivity measurements in thin films of tangled bundles of SWCNTs deposited on glass substrates indicate a factor of 2-10 increase in the conductivity within the sheet. Raman scattering studies of the B-SWCNTs show an increase in D-band strength (˜1350 cm⁻¹) that correlates with the amount of boron introduced into the electrode. The sharp line character of the nanotube G-band is maintained upon B-doping, indicating that the B-substitution maintains the integrity of the structure in the tube wall. So-called van Hove (H) optical absorption bands are observed in the B-SWCNTs, but they appear upshifted in photon energy relative to their positions in pristine tubes when the B-doping is high. The upshift increases with increasing B-content in the electrodes. The vH features are only characteristic of one-dimensional filaments (e.g., carbon nanotubes). These vH features are, therefore, not present in the optical spectra of other carbons produced in the arc (e.g., amorphous carbon carbon onions, carbon shells, graphitic flakes).

Thus, it can be seen that the objects of the invention have been satisfied by the structure and its method for use presented above. It is to be understood that the invention is not limited thereto or thereby. Accordingly, for an appreciation of true scope and breadth of the invention, reference should be made to the following claims.

1. A process for the manufacture of boron-doped single-walled carbon nanotubes comprising the steps of:
a) providing a first and second carbon source wherein at least one carbon source is a carbon source further comprising a boron source;
b) connecting a first carbon source to a negative terminal (cathode) of an electric arc discharge supply;
c) connecting a second carbon source to a positive terminal (anode) of an electric arc discharge supply;
d) placing the first and second carbon sources adjacent to each other in order to create an electrical arc gap; and
e) applying a discharge current between the first and second carbon sources whereby boron-doped carbon nanotubes are formed.

2. The process of claim 1, wherein the boron-containing carbon source is electrically connected to the negative terminal (cathode) of the electric arc discharge supply.

3. The process of claim 1, wherein the carbon sources are within an arc discharge reaction chamber.

4. The process of claim 1, wherein the process further comprises applying a vacuum to the arc discharge reaction chamber and introducing a protecting gas at a predetermined pressure therein.

5. The process of claim 4, wherein the protecting gas comprises helium, argon, nitrogen, hydrogen or mixtures thereof.

6. The process of claim 1, wherein at least one carbon source is a substantially pure graphite rod.

7. The process of claim 1, wherein at least one carbon source comprises a catalyst powder and high purity graphite particles.

8. The process of claim 7, wherein the catalyst powder is selected from the group consisting of nickel powder, ytterbia powder, a composite of nickel powder and ytterbia powder, cobalt powder or mixtures thereof.

9. The process of claim 1, wherein the boron-containing carbon source comprises from about 0.1 at. wt. % to about 15 at. wt. % of boron.

10. The process of claim 9, wherein the boron is selected from the group consisting of elemental boron, boron carbide, boron oxide, boron nitride, boron phosphide, and mixtures thereof.

11. The process of claim 1, wherein the arc gap is in the range from about 1 to about 6 mm.

12. The process of claim 1, wherein the discharge current is in the range from 50 to 400 amps.

13. The process of claim 1, wherein the process further comprises introducing diborane gas (B₂O₆) into the arc discharge during boron-doped carbon nanotube formation.

14. A composition comprising boron-doped single-walled carbon nanotubes prepared by the process of claim 1.

15. A process for the manufacture of boron-doped single-walled carbon nanotubes comprising the steps of:
a) providing a plurality of single-walled carbon nanotubes;
b) mixing the single-walled carbon nanotubes with a boron-containing and reactive material;
c) reacting the single-walled carbon nanotubes with the boron-containing and reactive material by increasing the temperature and adding ammonia;
whereby boron-doped carbon nanotubes are formed.

16. The process of claim 15, wherein the boron-containing and reactive material is a boron metal or boron compound.

17. The process of claim 16, wherein the boron compound is selected from the group consisting of boron carbide, boron oxides, boron nitrides, borated ceramics, borated hydrocarbons, boron glass, and boron mixtures with neutron reactive elements and nuclides.

18. The process of claim 15, wherein the boron-containing and reactive material is boric oxide (B₂O₃).

19. The process of claim 15, wherein the boron-containing and reactive material is boron carbide (BC₄).

20. The process of claim 15, wherein the system pressure is maintained at about 50 to about 1000 ton and the system temperature is maintained at about 600 to about 1400 C.

21. The process of claim 15, wherein the reaction time is from about 1 hour to about 24 hours.

22. The process of claim 15, wherein the method further comprises the step of dispersing the collected boron-doped nanotubes in a solvent.

23. The process of claim 15, wherein the method further comprises the step of spraying the solvent-dispersed boron-doped nanotubes onto a substrate to form a thin film.

24. A composition comprising boron-doped single-walled carbon nanotubes prepared by the process of claim 15.

25. A process for the manufacture of boron-doped single-walled carbon nanotubes comprising the steps of:
(a) providing a plurality of single-walled carbon nanotubes synthesized in a process that provides for a limited amount of wall defects (reactive sites);
(b) reacting a boron-containing and reactive material and single-walled carbon nanotubes in an appropriate solvent or surfactant to form a product; and
(c) heating the product to a temperature of about 600 to about 1400 C for a time sufficient to produce boron-doped single-walled carbon nanotubes.

26. The process of claim 25, wherein the boron-containing and reactive material is a boron metal or boron compound.

27. The process of claim 26, wherein the boron compound is selected from the group consisting of boron carbide, boron oxides, boron nitrides, borated ceramics, borated hydrocarbons, boron glass, and boron mixtures with neutron reactive elements and nuclides.

28. The process of claim 25, wherein the boron-containing and reactive material is boric oxide (B₂O₃).

29. The process of claim 25, wherein the boron-containing and reactive material is boron carbide (BC₄).

30. The process of claim 25, wherein the method further comprises step of filtering and/or drying the product before, during or after heating in step (c).

31. The process of claim 25, wherein the solvent is selected from the group consisting of: chloroform, chlorobenzene, water, acetic acid, acetone, acetonitrile, aniline, benzene, benzonitrile, benzyl alcohol, bromobenzene, bromoform, 1-butanol, 2-butanol, carbon disulfide, carbon tetrachloride, cyclohexane, cyclohexanol, decalin, dibromethane, diethylene glycol, diethylene glycol ethers, diethyl ether, diglyme, dimethoxymethane, N,N-dimethylformamide, ethanol, ethylamine, ethylbenzene, ethylene glycol ethers, ethylene glycol, ethylene oxide, formaldehyde, formic acid, glycerol, heptane, hexane, iodobenzene, mesitylene, methanol, methoxybenzene, methylamine, methylene bromide, methylene chloride, methylpyridine, morpholine, naphthalene, nitrobenzene, nitromethane, octane, pentane, pentyl alcohol, phenol, 1-propanol, 2-propanol, pyridine, pyrrole, pyrrolidine, quinoline, 1,1,2,2-tetrachloroethane, tetrachloroethylene, tetrahydrofuran, tetrahydropyran, tetralin, tetramethylethylenediamine, thiophene, toluene, 1,2,4-trichlorobenzene, 1,1,1-trichloroethane, 1,1,2-trichloroethane, trichloroethylene, triethylamine, triethylene glycol dimethyl ether, 1,3,5-trimethylbenzene, m-xylene, o-xylene, p-xylene, 1,2-dichlorobenzene, 1,3-dichlorobenzene, and 1,4-dichlorobenzene.

32. The process of claim 25, wherein the solvent is an alcohol selected from the group consisting of methanol, ethanol, 2,2,2-trifluoroethanol, 2-propanol, 2-butanol, n-pentanol, n-hexanol, cyclohexanol and n-heptanol.

33. The process of claim 25, wherein the temperature is maintained at about 800 to about 950 C.

34. A composition comprising boron-doped single-walled carbon nanotubes prepared by the process of claim 25.

35. A process for the manufacture of boron-doped single-walled carbon nanotubes comprising the steps of:
a) providing a plurality of single-walled carbon nanotubes synthesized in a process that provides for a limited amount of wall defects (reactive sites); and
b) reacting the single-walled carbon nanotubes with a boron-containing and reactive material;
whereby boron-doped carbon nanotubes are formed.

36. A composition comprising boron-doped single-walled carbon nanotubes prepared by the process of claim 35.

37. A process for the manufacture of boron-doped single-walled carbon nanotubes comprising the steps of:
(a) providing a plurality of single-walled carbon nanotubes synthesized in a process that provides for a limited amount of wall defects (reactive sites);
(b) reacting boric oxide (B₂O₃) and single-walled carbon nanotubes in an appropriate solvent for a time sufficient to form a boric oxide-single-walled carbon nanotube product; and
(c) heating the product to a temperature of about 650 to about 950 C for a time sufficient to produce boron-doped single-walled carbon nanotubes
wherein the solvent comprises an alcohol.

38. The process of claim 37, wherein the temperature is maintained at about 800 to about 950 C.

39. The process of claim 37, further comprising the step of refluxing the single-walled carbon nanotubes in an acidic environment prior to reacting with boric oxide (B₂O₃).

40. The process of claim 39, wherein the refluxing of the single-walled carbon nanotubes is performed in an environment comprising nitric acids at a concentration of 1-5M.

41. A composition comprising boron-doped single-walled carbon nanotubes prepared by the process of claim 37.
